(19) United States
(12) Patent Application Publication
(10) Pub. No.: US 2026/0227616 A1
(43) Pub. Date: Aug. 6, 2026

(54) AN OPTICAL ARRANGEMENT FOR USE IN OPTICAL MICROSCOPY

(71) Applicant: BLUE CUBE TECHNOLOGY (PTY) LTD, Stellenbosch (ZA)

(72) Inventors: Francois Eberhardt DU PLESSIS, Stellenbosch (ZA); Petrus Albertus LE ROUX, Rawsonville (ZA)

(21) Appl. No.: 19/159,068

(22) PCT Filed: Feb. 24, 2024
(86) PCT No.: PCT/IB2024/051785

§ 371 Date: Aug. 22, 2025

(30) Foreign Application Priority Data
Feb. 24, 2023 (ZA) 2023/02418

(51) Int. Cl. G02B 21/10; G01N 15/0227

(52) U.S. Cl. CPC G02B 21/10; G01N 15/0227

(57) ABSTRACT

An optical arrangement comprising: a reflector of a first refractive index comprising an input end configured to receive illumination light and an output end from which the illumination light exits the reflector after propagating therein; wherein the reflector comprises at least one reflective outer surface configured to reflect the illumination light internally within the reflector such that the reflected illumination light is angled in an inward direction towards a sample; and an observed medium of a second refractive index configured to be in direct contact with the output end of the reflector and with the sample such that the illumination light passes from the reflector through the observed medium to the sample without passing through another material with a refractive index lower than the second refractive index which is lower than the first refractive index.

### FIELD OF THE INVENTION

This invention relates to an optical arrangement for use in optical microscopy, in particular for use in reflected dark-field microscopy.

### BACKGROUND TO THE INVENTION

Current methods to provide high Numeric Aperture (“NA”) reflected dark-field illumination at the tip of a microscope objective are commonly achieved with one of the following two approaches:
1. A ring mirror is used to form a concave reflector around the objective lens which reflects illumination light onto a sample to be imaged; or
2. A refractive element, such as a ring condenser lens, is used around the objective lens or the outside annulus of an existing high NA objective lens which directs (via refraction) illumination light onto a sample to be imaged.

Note that the term “condenser” is commonly used to refer to a lens assembly for focusing illumination light onto a sample and the term “objective” is commonly used to refer to a lens assembly for collecting light scattered from the sample upon illumination. Note also that the term “objective” may be used to refer to a lens assembly configured for both focusing illumination light and collecting scattered light.

The above-mentioned two approaches to provide high Numeric Aperture (“NA”) reflected dark-field illumination at the tip of a microscope objective are complex and expensive to implement. Furthermore, in both approaches, the illumination light may pass through air before reaching the sample. Therefore, the maximum practically achievable NA of such an arrangement is limited to be less than 1. This is undesirable for certain imaging applications, particularly the reflected dark-field optical microscopy and particularly in respect of non-transparent samples with smooth, reflective surfaces.

Objects and aspects of the present claimed invention seek to alleviate at least these problems with the prior art.

### SUMMARY OF THE INVENTION

The present claimed invention solves the problems with the prior art by providing a simple, flexible and low-cost optical arrangement that is capable of providing reflected dark-field objective illumination with a high NA higher than 1, preferably as high as possible and preferably an NA of 1.1 or higher.

According to a first aspect of the present invention, there is provided an optical arrangement to provide illumination with an NA of more than 1, preferably an NA of 1.1 or higher for reflected dark-field microscopy. The optical arrangement may comprise a reflector of a first refractive index. The reflector may comprise an input end configured to receive illumination light and an output end from which the illumination light exits the reflector after propagating therein. The reflector may comprise at least one reflective outer surface configured to reflect the illumination light internally within the reflector such that the reflected illumination light is angled in an inward direction towards a sample. The optical arrangement may further comprise an observed medium of a second refractive index. The observed medium may be configured to be in direct contact with the output end of the reflector and with the sample such that the illumination light passes from the reflector through the observed medium to the sample without passing through another material with a refractive index lower than the second refractive index. The second refractive index may be lower than the first refractive index.

The proposed optical arrangement may enable flexible choice for objective front lens (e.g., for collecting scattered light from the sample) and long working distances. The maximum achievable NA may be limited only by the observed medium. Note that the invention is not the observed medium.

The term “observed medium” is used herein to refer to any suitable (e.g., liquid or solid) medium to which the sample to be observed is attached or within which the sample to be observed is suspended.

The term “sample” is used herein to refer to any object or matter that is sought to be observed and it could be combined with another medium. For example, the sample may be in the form of solid particles or cells suspended within a liquid observed medium (see below for more detail). The illumination light may extend on more than one side of the sample.

Note that the illumination is not necessarily from all sides of the sample. It may be desirable to illuminate only from two opposing sides or only from one side of the sample, in some applications. In some embodiments, the sample may be illuminated in photometric stereo, with different colours of illumination from different directions.

In an embodiment, the at least one reflective outer surface of the reflector is configured such that the illumination light undergoes total internal reflection at the at least one reflective outer surface. In this embodiment, the reflector may be surrounded by an ambient medium having a refractive index lower than the first refractive index of the reflector. For example, the reflector may be surrounded by air and the first refractive index of the reflector may be higher than 1, or preferably higher than 1.1. The at least one reflective outer surface may comprise no optical coating and may be angled with respect to the incident illumination light in such a manner that the requirement for total internal reflection of the illumination light at the at least one reflective outer surface is satisfied, that is to say, the angle of incidence of the illumination light at the at least one reflective outer surface is equal to or larger than the critical angle required for total internal reflection.

In an embodiment, the at least one reflective outer surface may comprise an optical coating (e.g., a silver coating, or a dielectric coating) configured to be highly reflective for the illumination light. The coating may have a reflectivity of e.g., more than 80%, or more than 90% in the wavelength range of the illumination light.

In an embodiment, at least part of the at least one reflective outer surface may be curved (e.g., outwardly towards the ambient environment of the reflector) such that upon reflection off the at least one reflective outer surface, the illumination light converges towards the sample. In an alternative embodiment, the reflective outer surface may be substantially flat.

In an embodiment, the reflector may comprise a frustoconical body with a frustoconical-shaped outer surface tapering from the input end to the output end. The frustoconical-shaped outer surface may provide the at least one reflective outer surface. The word “tapering” is used herein in a broad sense, which includes linear or non-linear tapering. A linearly tapered surface may correspond to a substantially flat surface whereas a nonlinearly tapered surface may correspond to a curved surface.

In an embodiment, the frustoconical body may comprise a sidewall defining a central cavity with at least a first opening at the input end. The sidewall may comprise the frustoconical-shaped outer surface. The optical arrangement may be operable such that light scattered from the sample enters the reflector via the output end and passes through the central cavity defined by the sidewall before exiting the reflector via the at least first opening of the central cavity at the input end.

In an embodiment, the central cavity defined by the sidewall may comprise a second opening at the output end, the second opening being smaller than the first opening. The scattered light from the sample may enter the central cavity via the second opening and may exit the central cavity via the first opening.

In an embodiment, the optical arrangement may further comprise a lens or lens assembly (e.g., a microscope objective) configured to collect the scattered light from the sample and optionally direct it towards a detection device. The lens or lens assembly may be placed in the central cavity of the frustoconical body.

In an embodiment, the sidewall may comprise an inner surface surrounding the central cavity. The inner surface may be a frustoconical-shaped surface. In an embodiment, the frustoconical-shaped inner surface may be configured such that the illumination light undergoes total internal reflection thereon. This may allow the illumination light to undergo one or more reflections within the reflector. The frustoconical-shaped inner surface may be substantially flat or curved. In an embodiment, the frustoconical-shaped inner surface is substantially parallel to the frustoconical-shaped outer surface. In an embodiment, such a frustoconical-shaped inner surface may be reflective in at least the wavelength range of the illumination light.

In an embodiment, the optical arrangement may further comprise an optical coupling medium of a third refractive index. The optical coupling medium may be substantially transparent to the illumination light and may be configured to be in direct contact with the output end of the reflector and the observed medium. The third refractive index of the optical coupling medium may be higher than the second refractive index of the observed medium. In an embodiment, the third refractive index of the optical coupling medium may be different to (e.g., higher, or lower than) the first refractive index of the reflector. In an embodiment, the third refractive index of the optical coupling medium may be substantially equal to the first refractive index of the reflector. The optical coupling medium may be a liquid medium or a solid medium. In an embodiment, the optical coupling medium may be in the form of an optical window, e.g., made of Sapphire. In a different embodiment, the optical coupling medium may comprise an optical window made of a same material (e.g., polycarbonate) as the reflector.

In an embodiment, the first refractive index and/or the second refractive index may be higher than 1.1.

In an embodiment, the first refractive index and/or the second refractive index may be higher than 1.3.

In an embodiment, the third refractive index may be higher than 1.1.

In an embodiment, the reflector may be made of polycarbonate.

In an embodiment, the observed medium may be a liquid medium. In an embodiment, the observed medium may be water. In an embodiment, the sample (e.g., solid particles or cells) may be suspended within the observed medium.

In an embodiment, the illumination light received at the input end of the reflector may comprise an annular-shaped intensity profile.

In an embodiment, the illumination light received at the input end of the reflector may be substantially collimated.

In an embodiment, the illumination light received at the input end of the reflector may be converged so that the light reflected off the at least one reflective outer surface would be focused on the sample.

In an embodiment, the reflector may comprise a light receiving surface at the input end arranged to be perpendicular to a propagation direction of the illumination light. This may minimise refraction and reflection of the illumination light as it enters the reflector.

According to a second aspect of the present invention, there is provided a reflection microscope. The reflection microscope may comprise an optical arrangement of any of the above embodiments and a light source operable to output the illumination light. The light source may output illumination light in an annulus and the illumination light may be substantially parallel (or collimated). Alternatively, the illumination light entering the reflector via its input end may be converging, so as to focus at a point inside the observed medium.

In an embodiment, the reflection microscope may further comprise an imaging device (e.g., a camera) operable to capture light scattered from the sample in the optical arrangement and record an image thereof.

In an embodiment, the reflection microscope may further comprise an imaging device operable to capture light specularly reflected from the sample in the optical arrangement and record an image thereof.

In an embodiment, the optical arrangement may be configured to determine a particle size of the sample.

In an embodiment, the reflection microscope may be configured to enable reflected dark-field microscopy of the sample. Such a reflection microscope may be used to perform for example particle sizing. The reflection microscope may be used to perform particle sizing by collecting specularly reflected light, reflected from the sample.

According to a third aspect of the present invention, there is provided a method of determining a particle size of a sample in a reflection microscope of the second aspect. The method may comprise: illuminating a sample with the illumination light; capturing light scattered and/or specularly reflected from the sample; generating an image of the captured light from the sample; and determining a particle size of the sample based on the generated image.

It will be appreciated that any features described herein as being suitable for incorporation into one or more aspects or embodiments of the present disclosure are intended to be generalizable across any and all aspects and embodiments of the present disclosure. Other aspects of the present disclosure can be understood by those skilled in the art in light of the description, the claims, and the drawings of the present disclosure. The foregoing general description and the following detailed description are exemplary and explanatory only and are not restrictive of the claims.

### BRIEF DESCRIPTION OF THE DRAWINGS

The invention will now be described by way of non-limiting example only with reference to the following Figures in which:

FIG. 1A shows a cross-sectional view along a longitudinal axis of an optical arrangement, in accordance with an embodiment;

FIG. 1b shows a top view of the optical arrangement of FIG. 1a;

FIG. 1C shows a simplified diagram which schematically illustrates the interaction of the illumination light and the sample (e.g., a particle);

FIG. 2A shows a cross-sectional view along a longitudinal axis of an optical arrangement, in accordance with a different embodiment;

FIG. 2B shows a top view of the optical arrangement of FIG. 2A;

FIG. 3 shows a cross-sectional view along a longitudinal axis of an optical arrangement, in accordance with another different embodiment; and

FIG. 4 shows an example image of two different types of particles obtained by a reflection microscope comprising the optical arrangement of FIGS. 1A, 2A, or 3.

### DETAILED DESCRIPTION

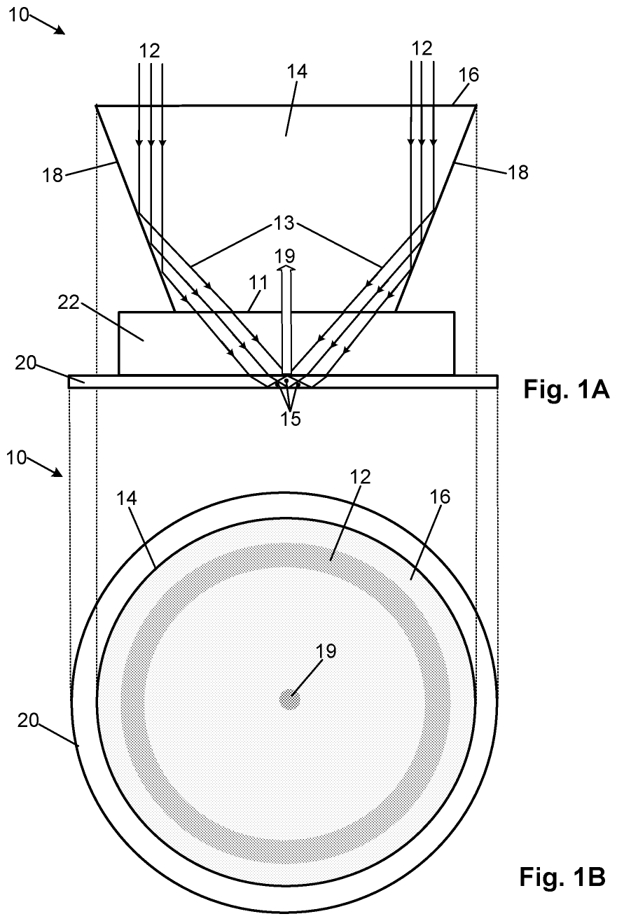

FIGS. 1A-1B, 2A-2B, and 3 are associated with embodiments of an optical arrangement for reflected dark-field microscopy, comprising: a reflector of a first refractive index, the reflector comprising an input end configured to receive illumination light and an output end from which the illumination light exits the reflector after propagating therein; wherein the reflector comprises at least one reflective outer surface configured to reflect the illumination light internally within the reflector such that the reflected illumination light is angled in an inward direction towards a sample; and an observed medium of a second refractive index, the observed medium configured to be in direct contact with the output end of the reflector and with the sample such that the illumination light passes from the reflector through the observed medium to the sample without passing through another material with a refractive index lower than the second refractive index; wherein the second refractive index is lower than the first refractive index.

With reference to FIGS. 1A and 1B, in an embodiment, the optical arrangement 10 comprises a reflector 14, an optical coupling medium 22 and an observed medium 20 within which samples 15 are comprised.

The reflector 14 comprises a frustoconical body 14 with a frustoconical-shaped outer surface 18 tapering from an input (e.g., top) end comprising a top surface 16 to an output (e.g., bottom) end comprising a bottom (or base or lower portion) surface 11 which interfaces with the optical coupling medium 22. The frustoconical body 14 may be surrounded by air and may be made of a material with a first refractive index. The first refractive index may be for example higher than 1.0, higher than 1.1, higher than 1.2, or higher than 1.3. In an example implementation, the frustoconical body 14 may be made of polycarbonate. In the embodiment where there comprises no optical coupling medium 22, the bottom surface 11 may be in direct contact with the observed medium. The top surface 16 is configured to receive illumination light 12 which propagates through the frustoconical body 14 before exiting from the bottom surface 11.

The top surface 16 of the frustoconical body 14 may be arranged to be perpendicular to a propagation direction of the illumination light 12 so as to minimise refraction and reflection of the illumination light 12 as it enters the frustoconical body 14. With reference to FIG. 1B, the illumination light 12 has an annular-shaped intensity profile. The illumination light 12 received at the top surface 16 of the frustoconical body 14 is substantially parallel (or collimated). In alternative embodiments, the illumination light 12 received at the top surface 16 of the frustoconical body 14 may be converged so that the light 13 reflected off the frustoconical-shaped outer surface 18 would be focused on the samples 15.

With reference to FIG. 1A, the frustoconical-shaped outer surface 18 is configured to reflect the illumination light 12 internally within the reflector 14 such that the reflected illumination light 13 is angled in an inward direction towards a samples 15. The frustoconical-shaped outer surface 18 is configured such that the illumination light 12 undergoes total internal reflection thereon. In other words, the angle of incidence of the illumination light 12 at the frustoconical-shaped outer surface 18 is equal to or larger than the critical angle required for total internal reflection. It will be appreciated that such a critical angle may be dependent on many factors such as the wavelength(s) of the illumination light, the refractive index of the frustoconical body 14, and the refractive index of the surrounding medium (e.g., air). In a different embodiment, the frustoconical-shaped outer surface 18 may be coated with an optical coating that is highly reflective in at least the wavelength range of the illumination light. The optical coating may be configured to have a reflectivity of for example at least 70%, at least 80%, at least 90% or at least 95% in at least the wavelength range of the illumination light.

In this embodiment, the frustoconical-shaped outer surface 18 is substantially flat such that after specular reflection from the surface 18, the reflected illumination light 13 is still substantially parallel (or collimated), as the incident illumination light 12. In an alternative embodiment, at least part of the frustoconical-shaped outer surface 18 may be curved outwardly such that upon reflection off the frustoconical-shaped outer surface 18, the reflected illumination light 13 converges towards the samples 15 (e.g., to form a focused ring of light in the observed medium 20).

With reference to FIG. 1A, the optical coupling medium 22 with a third refractive index is configured to be in direct contact with the bottom surface 11 of the frustoconical-shaped body 14 and with a top surface (not shown) of the observed medium 20 such that the reflected illumination light 13 passes from the frustoconical body 14 through the optical coupling medium 22 to the observed medium 20. The third refractive index may be for example higher than 1.0, higher than 1.1, higher than 1.2, or higher than 1.3. The third refractive index of the optical coupling medium 22 may be same as or different to the first refractive index of the frustoconical body 14. The optical coupling medium 22 may be used to increase the design flexibility of the proposed optical arrangement 10. For example, the optical coupling medium 22 may be used to help relax the total internal reflection geometric requirements.

In the embodiment of FIG. 1A or 1B, the optical coupling medium 22 is in the form of an optical window or an optical substrate that is substantially transparent to the illumination light 12 (and thus the reflected illumination light 13). As shown in FIG. 1A, the optical window 22 is configured to refract the reflected illumination light 13 so as to direct the light 13 towards the samples 15 in the observed medium 20. In an example implementation, the optical window 22 may be made of Sapphire. In alternative embodiments, the optical coupling medium 22 may be a liquid medium, e.g., comprised in a pouch, both the liquid medium and the pouch being substantially transparent to the reflected illumination light 13.

The optical coupling medium 22 is optional. In a different embodiment, there may comprise no optical coupling medium 22. As such, the observed medium is in direct contact with the bottom surface 11 of the frustoconical-shaped body 14 such that the reflected illumination light 13 passes from the frustoconical body 14 through the observed medium 20 to the samples 15.

The observed medium 20 with a second refractive index is configured to be in direct contact with a bottom surface (not shown) of the optical coupling medium 22 and with the samples 15 such that the reflected illumination light 13 passes from the optical coupling medium 22 through the observed medium 20 to the samples 15. The second refractive index may be for example higher than 1.0, higher than 1.1, higher than 1.2, or higher than 1.3. The second refractive index of the observed medium is lower than the first refractive index of the frustoconical body 14 as well as the third refractive index of the optical coupling medium 22. In such an arrangement, the reflected light 13 passes from the reflector 14 (e.g., frustoconical body 14) through the optical coupling medium 22 (e.g., optical window 22) and the observed medium 20 (e.g., water) to the samples 15 (e.g., solid particles) without passing through another material (e.g., air) with a refractive index lower than the second refractive index. As such, the optical arrangement 10 may be operable to form a ring of illumination light on the samples 15 with an NA of higher than 1 in the observed medium 20.

With reference to FIGS. 1B and 1C, upon entering the observed medium 20 and interacting with the samples 15 (e.g., particles or cells), the illumination light 13 may form a ring of light 31 on the outer surface of each individual sample (e.g., particle or cell). Each sample 15 may scatter at least part 19 of the ring of light 31 back towards the reflector 14 (e.g., frustoconical body 14). Such scattered light 19 may be collected by a lens or lens assembly (e.g., a microscope objective) placed outside (e.g., above) the reflector 14. The collected scattered light 19 may then be directed e.g., via one or more additional optical elements, to an imaging device (e.g., a camera) for image generation.

Further, owing to the high NA of the ring of illumination light 31 in the observed medium 20, when samples 15 are non-transparent and have smooth, reflective outer surfaces, at least part 19 of the illuminating light 13 may be specularly reflected back to the reflector 14 by the samples 15 and may be collected by the lens, lens assembly, microscope objective, or the like. The high NA illumination would cause the specularly reflected light to be reflected from the samples 15 at or near the peripheral boundaries of the particles, as viewed from the reflector 14, so that the reflected light 19 shows the profiles of the samples 15 (e.g., particles or cells). Therefore, when used for particle sizing applications, the proposed optical arrangement 10 enables a markable improvement over lower NA dark-field illumination, in which specularly reflected light is not captured, or if it is captured, it is reflected off the “front” of a particle 15 and is observed as a ring of light 31 that is markedly smaller than the actual profile of the particle 15.

When samples 15 have rough (dull) surfaces that reflect diffused light or the samples are transparent particles with smooth surfaces that relays back internally scattered (refracted) light, the high incidence angle of the high NA illumination provides a high irradiance at the peripheries of the samples, as viewed from the microscope objective, so that the outlines of particles are better visible through the objective, than with lower NA illumination.

It will be appreciated that not all the light scattered, refracted and/or reflected from the particle 15 will be collected for image generation. Some part (indicated by dashed arrows in FIG. 1C) of the scattered, refracted and/or reflected light may not be captured (e.g., which may be blocked/dumped).

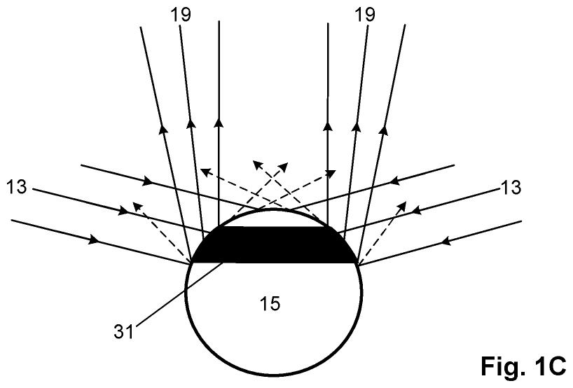

FIGS. 2A and 2B depict schematically an optical arrangement 10′ in accordance with a different embodiment. The main difference between the optical arrangement 10′ and the optical arrangement 10 may lie in the design of the reflector. The optical arrangement 10′ comprises a reflector 14′ according to a different design, an optical coupling medium 22 and an observed medium 22. Note that same references signs are used for parts or components of the optical arrangement 10′ shown in FIGS. 2A and 2B that are same as or similar to those of the optical arrangement 10 shown in FIGS. 1A and 1B. For the sake of simplicity, the details of those same or similar parts or components (e.g., the illumination light 12, the optical coupling medium 22, the observed medium 20) will not described again for this embodiment.

With reference to FIG. 2A, the reflector 14′ comprises a hollow frustoconical body 14′ which comprises a sidewall defining a central cavity 21 with a first opening 23 at the input end and a second opening 24 at the output end. The sidewall may comprise the frustoconical-shaped outer surface 18′. The second opening 24 is smaller than the first opening 23 due to the conically tapered outer surface 18′.

With reference to FIG. 2B, in operation, the scattered, refracted and/or reflected light 19 from the samples 15 (after passing through the observed medium and the optical coupling medium) enters the central cavity 21 of the frustoconical body 14′ via the second opening 24 and subsequently exits the central cavity 21 of the frustoconical body 14′ via the first opening. In an embodiment, the optical arrangement 10′ may further comprise a lens or lens assembly (e.g., a microscope objective) configured to collect the scattered, refracted and/or reflected light 19 from the samples 15 and optionally direct it towards an imaging device (e.g., camera) for image generation. Such a lens or lens assembly may be placed within the central cavity 21 of the frustoconical body 14′ of the optical arrangement 10′.

Comparing to the reflector 14 of the optical arrangement 10, the reflector 14′ of the optical arrangement may allow a microscope objective for collecting the scattered light to be placed closer to the samples 15, thereby allowing the use of a smaller microscope objective. On the other hand, the reflector 14 of the optical arrangement 10 may be easier to manufacture and thus may have a lower cost.

Referring back to FIG. 2A, the sidewall (and thus the frustoconical body 14′) may comprise a frustoconical-shaped inner surface 17 surrounding the central cavity 21. The frustoconical-shaped inner surface 17 may be substantially parallel to the frustoconical-shaped outer surface 18′. As such, the side wall may have a substantially constant internal transverse width. It will be appreciated that the inner surface 17 of the frustoconical body 14′ may be configured in other different ways. For example, the inner surface 17 of the frustoconical body 14′ may be substantially perpendicular to (or in any other angle with) the bottom (or base or lower portion) surface 11′ of the frustoconical body 14′.

In an embodiment, the frustoconical-shaped inner surface 17 may be reflective (e.g., via total internal reflection) in at least the wavelength range of the illumination light. This may allow the illumination light 12 to undergo one or more reflections within the sidewall of the frustoconical body 14′. Similar to the outer surface 18′ of the frustoconical body 14′, the inner surface 17 may also be substantially flat or curved (e.g., curved outwardly towards the central cavity 21).

For both optical arrangements 10, 10′, it is important that the frustoconical body 14, 14′ is optically coupled to the samples 15 so that the reflected illumination light 13 does not pass through any material (e.g., air) with a low refractive index (i.e. lower than that of the observed medium 20). For this purpose, the optional optical window 22 and the water in the observed medium 20 are in direct contact with the frustoconical body 14, 14′ and the samples 15, respectively.

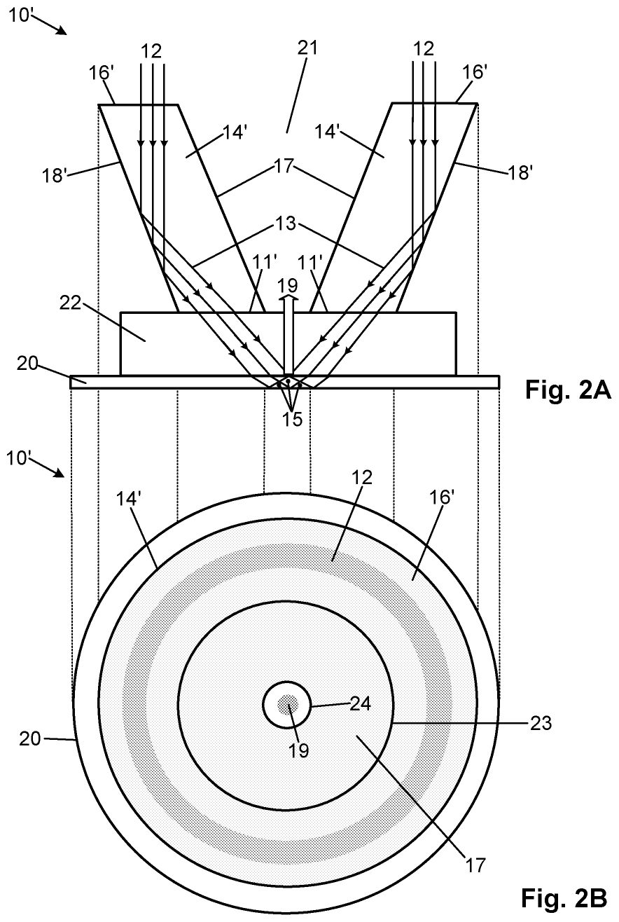

FIG. 3A depicts schematically an optical arrangement 10″ in accordance with a different embodiment. The optical arrangement 10″ comprises a reflector 14″ and an observed medium 20. Similar to the optical arrangement 10′, the reflector 14″ of the optical arrangement 10″ also comprises a hollow frustoconical body 14″ which comprises a sidewall defining a central cavity 21″ with two openings. The sidewall comprises a frustoconical-shaped outer surface 18″ and a frustoconical-shaped inner surface 17″ which may be substantially parallel to each other.

In absence of the optical coupling medium 22, the observed medium 20 is in direct contact with the frustoconical body 14″. As such, the reflected illumination light 13 enters the observed medium 20 directly after exiting the frustoconical body 14″ via its bottom (or base or lower portion) surface 11″. The angle of between the outer surface 18″ and the bottom surface 11″ of the frustoconical body 14″ may be appropriately set to enable simultaneously total internal reflection of the illumination light 12 at the outer surface 18″ and formation of a ring of illumination light on the samples 15 within the observed medium 20.

The optical arrangement 10″ may further comprise a lens or lens assembly configured to collect light scattered from the samples 15 in the observed medium 20. Such a lens or lens assembly may be placed within the central cavity 21″ of the frustoconical body 14″. In a different aspect of the present disclosure, there is provided a reflection microscope, comprising: an optical arrangement of any of the foregoing embodiments 10, 10′, 10″; and a light source operable to output the illumination light 12. The light source may output illumination light 12 in an annulus and the illumination light may be substantially parallel or collimated. Alternatively, the illumination light entering the reflector via its input end may be converging, so as to focus at a point inside the observed medium.

The reflection microscope may further comprise an imaging device operable to capture light 19 scattered, refracted and/or reflected from the samples 15 in the optical arrangement 10, 10′ or 10″ and record an image thereof.

In an embodiment, the reflection microscope may be configured in a dark-field imaging mode which aims to exclude the un-scattered illumination light from being captured by the imaging device.

In an embodiment, the reflection microscope may comprise multiple light sources and multiple reflectors 14, 14′, 14″, which are preferably spaced around the sample, but could potentially illuminate the sample only from selected directions.

In normal dark-field imaging, the reflection microscope may be used to collect light from samples in two main groups:
Group 1: Particles with rough (dull) surfaces, giving off diffused light reflection.
Group 2: Mostly transparent particles with smooth surfaces, relaying back internally scattered (refracted) light and surface specular light reflection.

Normal dark-field imaging specifically aims to exclude unscattered light. However, if such unscattered light from low NA illumination were reflected and captured, the light would be reflected of the “front” of the particles as viewed from the microscope objective, and boundaries of the samples would not be well illuminated and/or would not reflect light to the objective, so that particles would appear smaller than they are.

Surprisingly, benefiting from its high NA illumination, the reflection microscope disclosed herein also seeks to capture specularly reflected light, reflected from surfaces of a third group of samples:
Group 3: Mostly non-transparent particles with smooth surfaces, giving off only surface specular light reflection.

Capturing specularly reflected light from these samples while using high NA illumination, allows light to be reflected from the boundaries of the samples, or near the boundaries of the samples, so that the reflected light that is captured resembles the actual profiles of the particles with higher accuracy that what was possible in the prior art.

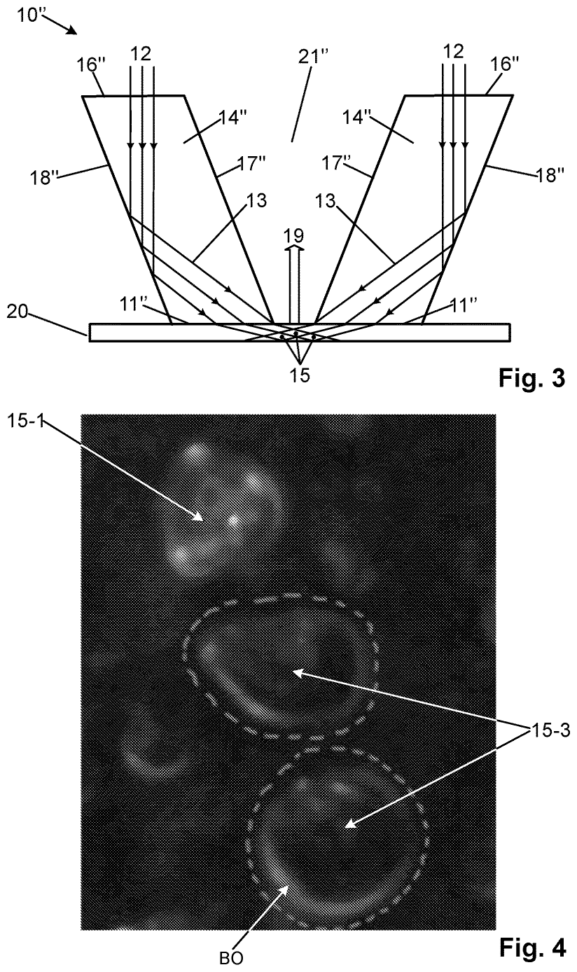

FIG. 4 shows an example image of two different types of particles 15-1 and 15-3 obtained by the reflection microscope comprising the optical arrangement of FIGS. 1A, 2A, or 3. The particle 15-1 is a Group 1 particle and thus has a dull surface which diffuses the illumination light. At least part of such diffused light may be captured by the imaging device of the reflection microscope. By contrast, the particles 15-3 (circled by dashed lines) are Group 3 particles and thus have smooth and reflective outer surfaces which specularly reflect the illumination light. Thus, at least part of such specularly reflected light may be captured by the imaging device of the reflection microscope. The high NA illumination of the reflection microscope allows the true boundaries BO of the particles 15-3 to be more accurately imaged than was previously possible. Therefore, the example image demonstrates the applicability of the proposed reflection microscope for imaging particles of all three particle groups, which is unachievable by prior art reflection microscopes with a low NA illumination.

Using the proposed reflection microscope to determine a particle size of a sample may comprise for example the following four main steps:
Step 1: illuminating a sample with the high NA illumination light.
Step 2: capturing light scattered, refracted and/or specularly reflected from the sample;
Step 3: generating an image of the captured light from the sample; and
Step 4: determining a particle size of the sample based on the generated image.

In some embodiments, the sample may be illuminated in photometric stereo. In one example, particles in the sample may be illuminated with different colours of illumination from different directions, so that boundaries of the particles facing different directions are illuminated in different colours and individual particles are easier to distinguish in a captured image.

The description provided herein may be directed to specific implementations. It should be understood that the discussion provided herein is provided for the purpose of enabling a person with ordinary skill in the art to make and use any subject matter defined herein by the subject matter of the claims.

It should be intended that the subject matter of the claims is not limited to the implementations and illustrations provided herein, but include modified forms of those implementations including portions of implementations and combinations of elements of different implementations in accordance with the claims. It should be appreciated that in the development of any such implementation, as in any engineering or design project, numerous implementation-specific decisions should be made to achieve a developers' specific goals, such as compliance with system-related and business-related constraints, which may vary from one implementation to another. Moreover, it should be appreciated that such a development effort may be complex and time consuming, but would nevertheless be a routine undertaking of design, fabrication, and manufacture for those of ordinary skill having benefit of this invention.

Reference has been made in detail to various implementations, examples of which are illustrated in the accompanying drawings and figures. In the detailed description, numerous specific details are set forth to provide a thorough understanding of the invention provided herein. However, the invention provided herein may be practiced without these specific details. In some other instances, well-known methods, procedures, components, circuits, and networks have not been described in detail so as not to unnecessarily obscure details of the embodiments.

It should also be understood that, although the terms first, second, etc. may be used herein to describe various elements, these elements should not be limited by these terms. These terms are only used to distinguish one element from another. For example, a first element could be termed a second element, and, similarly, a second element could be termed a first element. The first element and the second element are both elements, respectively, but they are not to be considered the same element.

The terminology used in the description of the invention provided herein is for the purpose of describing particular implementations and is not intended to limit the invention provided herein. As used in the description of the invention provided herein and appended claims, the singular forms “a,” “an,” and “the” are intended to include the plural forms as well, unless the context clearly indicates otherwise. The term “and/or” as used herein refers to and encompasses any and all possible combinations of one or more of the associated listed items. The terms “includes,” “including,” “comprises,” and/or “comprising,” when used in this specification, specify a presence of stated features, integers, steps, operations, elements, and/or components, but do not preclude the presence or addition of one or more other features, integers, steps, operations, elements, components and/or groups thereof.

As used herein, the term “if” may be construed to mean “when” or “upon” or “in response to determining” or “in response to detecting,” depending on the context. Similarly, the phrase “if it is determined” or “if [a stated condition or event] is detected” may be construed to mean “upon determining” or “in response to determining” or “upon detecting [the stated condition or event]” or “in response to detecting [the stated condition or event],” depending on the context.

While the foregoing is directed to implementations of various techniques described herein, other and further implementations may be devised in accordance with the invention herein, which may be determined by the claims that follow. Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims.

1. An optical arrangement for reflected dark-field microscopy, comprising:
a reflector of a first refractive index, the reflector comprising an input end configured to receive illumination light and an output end from which the illumination light exits the reflector after propagating therein; wherein the reflector comprises at least one reflective outer surface configured to reflect the illumination light internally within the reflector such that the reflected illumination light is angled in an inward direction towards a sample; and
an observed medium of a second refractive index, the observed medium configured to be in direct contact with the output end of the reflector and with the sample such that the illumination light passes from the reflector through the observed medium to the sample without passing through another material with a refractive index lower than the second refractive index; wherein the second refractive index is lower than the first refractive index
so that the sample is illuminated with the illuminating light with a NA higher than 1.

2. The optical arrangement as claimed in claim 1, wherein the NA is 1.1 or higher.

3. The optical arrangement as claimed in claim 1, wherein the at least one reflective outer surface of the reflector is configured such that the illumination light undergoes total internal reflection thereon and preferably wherein at least part of the at least one reflective outer surface is either curved or substantially flat.

4-5. (canceled)

6. The optical arrangement as claimed in claim 1, wherein the reflector comprises a frustoconical body with a frustoconical-shaped outer surface tapering from the input end to the output end; and
wherein the frustoconical-shaped outer surface comprises the at least one reflective outer surface.

7. The optical arrangement as claimed in claim 6, wherein the frustoconical body comprises a sidewall defining a central cavity with at least a first opening at the input end and comprising the frustoconical-shaped outer surface and preferably being operable such that light scattered from the sample enters the reflector via the output end and passes through the central cavity defined by the sidewall before exiting the reflector via the at least first opening of the central cavity at the input end.

8. (canceled)

9. The optical arrangement as claimed in claim 7, wherein the central cavity defined by the sidewall comprises a second opening at the output end, the second opening being smaller than the first opening.

10. The optical arrangement as claimed in claim 7, wherein the sidewall comprises a frustoconical-shaped inner surface surrounding the central cavity, that is configured such that the illumination light undergoes total internal reflection thereon and that is preferably substantially parallel to the frustoconical-shaped outer surface.

11-12. (canceled)

13. The optical arrangement as claimed in claim 10, wherein the frustoconical-shaped inner surface is either curved or substantially flat.

14. (canceled)

15. The optical arrangement as claimed in claim 1, further comprising an optical coupling medium (such as an optical window) of a third refractive index; and wherein the optical coupling medium is substantially transparent to the illumination light and configured to be in direct contact with the output end of the reflector and the observed medium, the third refractive index being higher than the second refractive index, preferably wherein the third refractive index is either different to or substantially equal to the first refractive index of the reflector.

16-20. (canceled)

21. The optical arrangement as claimed in claim 9, wherein one or more of the first refractive index, the second refractive index and the third refractive index is higher than 1.1.

22-24. (canceled)

25. The optical arrangement as claimed in claim 1, wherein the observed medium is a liquid medium such as water.

26. (canceled)

27. The optical arrangement as claimed in claim 1, wherein the sample is suspended within the observed medium.

28. The optical arrangement as claimed in claim 1, wherein the illumination light received at the input end of the reflector has an annular-shaped intensity profile and is preferably substantially collimated.

29. (canceled)

30. The optical arrangement as claimed in claim 1, wherein the illumination light received at the input end of the reflector is converged.

31. The optical arrangement as claimed in claim 1, wherein the reflector comprises a light receiving surface at the input end arranged to be perpendicular to a propagation direction of the illumination light.

32. The optical arrangement as claimed in claim 1, further comprising a lens or lens assembly configured to collect light scattered from the sample upon illumination.

33. A reflection microscope, comprising:
an optical arrangement being configured to enable reflected dark-field microscopy of the sample and to illuminated the sample with an NA higher than 1 as claimed in claim 1; and
a light source operable to output the illumination light.

34. The reflection microscope as claimed in claim 33, further comprising an imaging device operable to capture light scattered from, and/or refracted from, and/or specularly reflected from, the sample in the optical arrangement and to record an image thereof.

35-36. (canceled)

37. The reflection microscope as claimed in claim 34, in which said optical arrangement is configured to determine a particle size of the sample.

38. A method of determining a particle size of a sample in a reflection microscope as claimed in claim 33, comprising:
illuminating a sample with the illumination light;
capturing light scattered and/or specularly reflected from the sample;
generating an image of the captured light from the sample; and
determining a particle size of the sample based on the generated image.
